(19) United States
(12) Patent Application Publication
(10) Pub. No.: US 2025/0358298 A1
(43) Pub. Date: Nov. 20, 2025

(54) HARMLESS ATTACK VERIFICATION AND ANALYSIS METHOD AND SYSTEM

(71) Applicant: Huaneng Information Technology Co., Ltd., Qingdao (CN)

(72) Inventors: Shuo Han, Qingdao (CN); Sheng Ye, Qingdao (CN); Hao Guo, Qingdao (CN); Qifeng Wu, Qingdao (CN); Lei Chen, Qingdao (CN); Faxing Chen, Qingdao (CN); Fuhai Gao, Qingdao (CN); Yan Li, Qingdao (CN); Yuxiang Lu, Qingdao (CN)

(73) Assignee: Huaneng Information Technology Co., Ltd., Qingdao (CN)

(21) Appl. No.: 19/281,522

(22) Filed: Jul. 25, 2025

(30) Foreign Application Priority Data
Jun. 6, 2025 (CN) CN202510756817.X

(51) Int. Cl. H04L 9/40

(52) U.S. Cl. CPC H04L 63/1416; H04L 63/1433

(57) ABSTRACT

Provided are harmless attack verification and analysis method and system. The method includes: acquiring multi-source security data, determining attack cases in the data to construct an attack knowledge graph; constructing a scenario-based attack flow chart based on the graph, and formulating a harmless attack task based on the chart; determining a number of paths and a number of nodes of attack paths in the harmless attack task, and decomposing the harmless attack task into sub-tasks based on the number of paths and the number of nodes; acquiring path information of each attack path, determining a complexity of the attack path based on the path information, and determining attack priorities of the sub-tasks based on the complexities of the attack paths; and determining an attack sequence of the sub-tasks based on the attack priorities, and performing simulated attack verification on a protection boundary by the sub-tasks in the attack sequence.

### CROSS-REFERENCE TO RELATED APPLICATIONS

This application claims priority of Chinese Patent Application No. 202510756817.X, filed on Jun. 6, 2025, the contents of which are hereby incorporated by reference.

### TECHNICAL FIELD

The present disclosure relates to the field of network security technology, and in particular, to a harmless attack verification and analysis method and system.

### BACKGROUND

In today's digital era, network security has become an important issue that organizations and individuals need to pay urgent attention to. With the increasing sophistication of network attack technologies and the normalization of advanced persistent threats, network attacks are becoming more complex and frequent. Traditional passive defense systems gradually expose shortcomings such as delayed detection and slow response when facing attack chains with high concealment and variable paths. Security experts and organizations need to continuously improve their response and protection capabilities. Therefore, harmless attack verification and analysis methods emerge as the times require, with their core goal being how to simulate real attack behaviors in an isolated environment to ensure that the verification process is safe and controllable, avoiding damage to the production environment.

### SUMMARY

To solve the above technical problems, the present disclosure provides a harmless attack verification and analysis method and system. The method includes:
acquiring multi-source security data, determining attack cases in the multi-source security data, and constructing an attack knowledge graph based on the attack cases in the multi-source security data;
constructing a scenario-based attack flow chart based on the attack knowledge graph, and formulating a harmless attack task based on the attack flow chart;
determining a number of paths and a number of nodes of attack paths in the harmless attack task, and decomposing the harmless attack task into a plurality of sub-tasks based on the number of paths and the number of nodes of the attack paths;
acquiring path information of each attack path, determining a complexity of the each attack path based on the path information, and determining attack priorities of the sub-tasks based on the complexities of the attack paths; and
determining an attack sequence of the sub-tasks based on the attack priorities, and performing simulated attack verification on a protection boundary by the sub-tasks in the attack sequence.

Further, said “acquiring multi-source security data, determining attack cases in the multi-source security data, and constructing an attack knowledge graph based on the attack cases in the multi-source security data” includes:
acquiring the multi-source security data on a network through a web crawler, and performing preprocessing on the multi-source security data, where the preprocessing includes data cleaning and data standardization processing;
identifying attack events from the preprocessed multi-source security data, and determining the attack cases in the multi-source security data based on the attack events;
using a preset extraction model to extract entities involved in the attack cases, and analyzing relationships among different entities in the attack cases based on dependency syntax; and
constructing the attack knowledge graph based on the entities and the relationships among the entities, and periodically updating the attack knowledge graph.

Further, said “constructing a scenario-based attack flow chart based on the attack knowledge graph, and formulating a harmless attack task based on the attack flow chart” includes:
determining attack scenarios corresponding to different attack cases in the attack knowledge graph, and determining attackers, attack targets, attack methods, and attack paths in the attack cases in different attack scenarios; and
drawing the attackers, the attack targets, the attack methods, and the attack paths into an attack flow chart in a graphical manner, importing the attack flow chart into a preset harmless attack engine, and automatically generating the harmless attack task by the preset harmless attack engine.

Further, said “determining a number of paths and a number of nodes of attack paths in the harmless attack task, and decomposing the harmless attack task into a plurality of sub-tasks based on the number of paths and the number of nodes of the attack paths” includes:
determining the number of paths and the number of nodes in the attack paths in the harmless attack task, calculating a product of the number of paths and the number of nodes, and decomposing the harmless attack task into the plurality of sub-tasks according to a result of the product.

Further, said “acquiring path information of each attack path, determining a complexity of the each attack path based on the path information” includes:
acquiring the path information of the each attack path, where the path information includes static indicators and dynamic indicators, and analyzing the static indicators and the dynamic indicators to determine indicator values corresponding to the static indicators and the dynamic indicators;
converting the static indicators and the dynamic indicators into vectors respectively, and normalizing vectorized static indicators and vectorized dynamic indicators to obtain weights corresponding to the static indicators and the dynamic indicators respectively;
determining a static complexity of the each attack path according to the indicator values and weights of the static indicators, and determining a dynamic complexity of the each attack path according to the indicator values and weights of the dynamic indicators; and
adding the static complexity of the each attack path and the dynamic complexity of the each attack path to obtain the complexity of the each attack path.

Further, said “analyzing the static indicators and the dynamic indicators to determine indicator values corresponding to the static indicators and the dynamic indicators” includes:
determining the static indicators and the dynamic indicators, where the static indicators include path length, vulnerability exploitation difficulty, and tool maturity, and the dynamic indicators include protection device coverage, environment context matching degree, and attacker resource requirements, and respectively evaluating and assigning values to the indicators in the static indicators and the dynamic indicators to obtain the indicator values corresponding to the static indicators and the dynamic indicators.

Further, said “determining a static complexity of the each attack path according to the indicator values and weights of the static indicators, and determining a dynamic complexity of the each attack path according to the indicator values and weights of the dynamic indicators” includes:
calculating the static complexity of the each attack path according to the indicator values and weights of the static indicators, where a calculation formula for the static complexity of the each attack path is:

$$A = {\sum }_{i = 1}^{n} qi * li ,$$

where A is the static complexity of the each attack path, qi is the weight of an i-th indicator in the static indicators, li is the indicator value of the i-th indicator in the static indicators, and n is a number of indicators in the static indicators; and
calculating the dynamic complexity of the each attack path according to the indicator values and weights of the dynamic indicators, where a calculation formula for the dynamic complexity of the each attack path is:

$$B = {\sum }_{i = 1}^{m} pi * ji ,$$

where B is the dynamic complexity of the each attack path, pi is the weight of an i-th indicator in the dynamic indicators, Ji is the indicator value of the i-th indicator in the dynamic indicators, and m is a number of indicators in the dynamic indicators.

Further, said “determining attack priorities of the sub-tasks based on the complexities of the attack paths” includes:
presetting an attack priority-complexity interval correspondence, where in the attack priority-complexity interval correspondence, each complexity interval is associated with a corresponding attack priority; and
acquiring a complexity of each sub-task, and based on a mapping relationship of a complexity interval to which the complexity belongs in the attack priority-complexity interval correspondence, selecting an attack priority corresponding to the complexity interval as the attack priority of the each sub-task.

Further, said “determining an attack sequence of the sub-tasks based on the attack priorities, and performing simulated attack verification on a protection boundary by the sub-tasks in the attack sequence” includes:
determining dependency relationships among the sub-tasks, constructing a directed acyclic graph of the sub-tasks according to the dependency relationships, and generating a topological sequence of the sub-tasks according to the directed acyclic graph;
determining the attack priorities of the sub-tasks, and adjusting the topological sequence according to the attack priorities of the sub-tasks to obtain the attack sequence of the sub-tasks; and
allocating the sub-tasks to different simulation nodes, and executing a corresponding sub-task of each simulation node in the attack sequence to perform the simulated attack verification on the protection boundary.

The present disclosure further provides a harmless attack verification and analysis system, including:
a construction module configured to acquire multi-source security data, determine attack cases in the multi-source security data, and construct an attack knowledge graph based on the attack cases in the multi-source security data;
a formulation module configured to construct a scenario-based attack flow chart based on the attack knowledge graph, and formulate a harmless attack task based on the attack flow chart;
a decomposition module configured to determine a number of paths and a number of nodes of attack paths in the harmless attack task, and decompose the harmless attack task into a plurality of sub-tasks based on the number of paths and the number of nodes of the attack paths;
a determination module configured to acquire path information of the each attack path, determine a complexity of the each attack path based on the path information, and determine attack priorities of the sub-tasks based on the complexities of the attack paths; and
a verification module configured to determine an attack sequence of the sub-tasks based on the attack priorities, and perform simulated attack verification on a protection boundary by the sub-tasks in the attack sequence.

Compared with the prior art, the harmless attack verification and analysis method and system provided by the embodiments of the present disclosure have the following beneficial effects:
in the present disclosure, constructing the attack knowledge graph is helpful to systematically organizing and presenting attack-related information, including the relationships among attack types, attackers, victims, and attack means, thereby helping security teams better understand the backgrounds and patterns of attack events, and improving the awareness and prevention capabilities against threats;
in the present disclosure, through the scenario-based attack flow chart, the attack paths and behaviors of the attackers can be clearly revealed, which is helpful to simulating and understanding attack processes, so as to formulate the harmless attack task and help organizations perform security drills and identify weaknesses and vulnerabilities in a system;
in the present disclosure, decomposing the harmless attack task into the sub-tasks is helpful to more effectively managing and executing the attack processes, by evaluating the complexities of the attack paths, the difficulty of the attacks can be determined, and the attack paths with high risk and high complexity are preferentially processed;
in the present disclosure, determining the attack priorities and sequence of the sub-tasks can help the security teams carry out more targeted protection and coping measures, and executing the attack task in sequence according to the attack priorities can improve the effect of the security drills and the security of the system; and
in the present disclosure, through the simulated attack verification, the security and weaknesses of the system can be evaluated, thereby helping the organizations improve protection strategies and improve the security level.

### BRIEF DESCRIPTION OF THE DRAWINGS

FIG. 1 is a schematic structure diagram of a process flow of a harmless attack verification and analysis method in an embodiment of the present disclosure; and

FIG. 2 is a schematic composition diagram of a harmless attack verification and analysis system in an embodiment of the present disclosure.

The specific implementations of the present application will be described in further detail below in conjunction with the drawings and embodiments. The following embodiments are used to illustrate the present disclosure, but should not be used to limit the scope of the present disclosure.

In the description of the present application, it should be understood that the orientations or positional relationships indicated by the terms “center”, “upper”, “lower”, “front”, “rear”, “left”, “right”, “vertical”, “horizontal”, “top”, “bottom”, “inner”, “outer”, etc. are the orientations or positional relationships based on what is shown in the accompanying drawings, and are merely intended to facilitate describing the present application and simplify the description, rather than indicating or implying that a platform or element referred to must have a specific orientation, and be constructed and operated in a specific orientation, and therefore cannot be construed as a limitation to the present application.

The terms “first” and “second” are used for descriptive purposes only and cannot be understood as indicating or implying relative importance or implicitly indicating the number of indicated technical features. Therefore, the features defined with “first” and “second” may explicitly or implicitly include one or more of the features. In the description of the present application, unless otherwise specified, “a plurality of” means two or more.

In the description of the present application, it should be noted that the terms “installation”, “coupling”, and “connection” should be understood in a broad sense unless explicitly specified and limited otherwise. For example, they may be a fixed connection, a detachable connection, or an integrated connection; a mechanical connection or an electrical connection; a direct coupling, an indirect coupling through an intermediate medium, or an internal communication of two elements. For those of ordinary skill in the art, the specific meanings of the above terms in the present application may be understood in light of the specific circumstances.

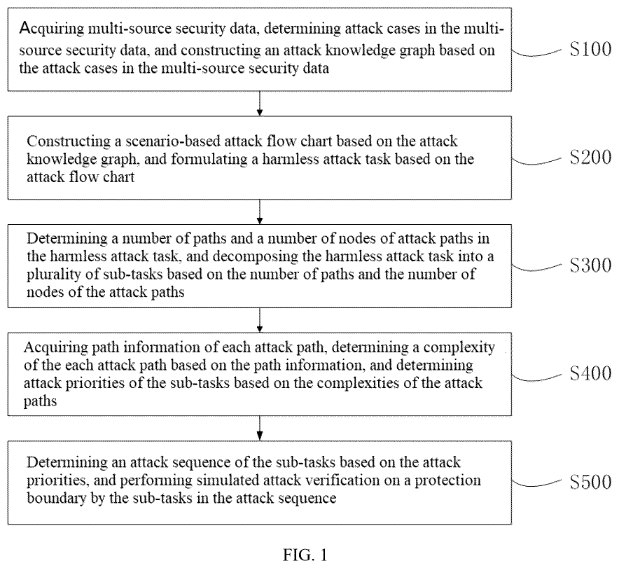

As shown in FIG. 1, in an embodiment of the present application, there is provided a harmless attack verification and analysis method, including: S100: acquiring multi-source security data, determining attack cases in the multi-source security data, and constructing an attack knowledge graph based on the attack cases in the multi-source security data; S200: constructing a scenario-based attack flow chart based on the attack knowledge graph, and formulating a harmless attack task based on the attack flow chart; S300: determining a number of paths and a number of nodes of attack paths in the harmless attack task, and decomposing the harmless attack task into a plurality of sub-tasks based on the number of paths and the number of nodes of the attack paths; S400: acquiring path information of each attack path, determining a complexity of the each attack path based on the path information, and determining attack priorities of the sub-tasks based on the complexities of the attack paths; S500: determining an attack sequence of the sub-tasks based on the attack priorities, and performing simulated attack verification on a protection boundary by the sub-tasks in the attack sequence.

Further, in the present disclosure, constructing the attack knowledge graph is helpful to systematically organizing and presenting attack-related information, including the relationships among attack types, attackers, victims, and attack means, thereby helping security teams better understand the backgrounds and patterns of attack events, and improving the awareness and prevention capabilities against threats; in the present disclosure, through the scenario-based attack flow chart, the attack paths and behaviors of the attackers can be clearly revealed, which is helpful to simulating and understanding attack processes, so as to formulate the harmless attack task and help organizations perform security drills and identify weaknesses and vulnerabilities in a system; in the present disclosure, decomposing the harmless attack task into the sub-tasks is helpful to more effectively managing and executing the attack processes, by evaluating the complexities of the attack paths, the difficulty of the attacks can be determined, and the attack paths with high risk and high complexity are preferentially processed; in the present disclosure, determining the attack priorities and sequence of the sub-tasks can help the security teams carry out more targeted protection and coping measures, and executing the attack task in sequence according to the attack priorities can improve the effect of the security drills and the security of the system; and in the present disclosure, through the simulated attack verification, the security and weaknesses of the system can be evaluated, thereby helping the organizations improve protection strategies and improve the security level.

In an embodiment of the present application, there is provided a harmless attack verification and analysis method, and said “acquiring multi-source security data, determining attack cases in the multi-source security data, and constructing an attack knowledge graph based on the attack cases in the multi-source security data” includes: acquiring the multi-source security data on a network through a web crawler, and performing preprocessing on the multi-source security data, where the preprocessing includes data cleaning and data standardization processing; identifying attack events from the preprocessed multi-source security data, and determining the attack cases in the multi-source security data based on the attack events; using a preset extraction model to extract entities involved in the attack cases, and analyzing relationships among different entities in the attack cases based on dependency syntax; and constructing the attack knowledge graph based on the entities and the relationships among the entities, and periodically updating the attack knowledge graph.

Specifically, web crawler technology is used to collect the multi-source security data from the network, these data may include security reports, vulnerability bulletins, security forum discussions, malware samples, etc., and acquiring the multi-source security data can help to establish a comprehensive security intelligence database to provide data support for subsequent security analysis and defense; for the data preprocessing (data cleaning and data standardization processing), the data cleaning includes removing duplicate data, processing missing values, correcting error data, etc. to ensure data quality, the data standardization processing includes unifying data formats, converting units, etc. to facilitate subsequent analysis and processing, and through the data preprocessing, data quality and consistency are improved to provide a clean and accurate data foundation for subsequent analysis; through data analysis and mining technology, the attack events in the multi-source security data are identified and the attack cases are determined, and identifying the attack events is helpful for the organizations respond to and cope with security threats in a timely manner, thereby improving security protection capabilities; the preset extraction model is used to extract the entities involved in the attack cases, such as attackers, victims, attack means, etc., the relationships among different entities in the attack cases are analyzed based on the dependency syntax, such as the attack behaviors of the attackers on the victims, and through entity extraction and relationship analysis, the participants and correlations of the attack events are deeply understood, which is helpful to forming a more comprehensive description of the attack events; and the attack knowledge graph is constructed based on the entities and the relationships among the entities, thereby revealing the attack events, entities, and relationships in the form of a graph, the attack knowledge graph is periodically updated, including adding new attack events and entity information, updating the relationships, etc., to reflect the latest security threat situations, and constructing the attack knowledge graph is helpful to systematically organizing and presenting attack-related information, thereby helping the security teams better understand the backgrounds and patterns of attack events, and improving the awareness and prevention capabilities against threats. In conclusion, this step can help the organizations extract useful information from the multi-source security data, construct the attack knowledge graph, and improve the perception and understanding of security threats, thereby strengthening security protection and coping capabilities, and through systematic methods and steps, different types of security threats can be better analyzed and coped with, thereby ensuring the security of an information system.

In an embodiment of the present application, there is provided a harmless attack verification and analysis method, said “constructing a scenario-based attack flow chart based on the attack knowledge graph, and formulating a harmless attack task based on the attack flow chart” includes: determining attack scenarios corresponding to different attack cases in the attack knowledge graph, and determining attackers, attack targets, attack methods, and attack paths in the attack cases in different attack scenarios; and drawing the attackers, the attack targets, the attack methods, and the attack paths into an attack flow chart in a graphical manner, importing the attack flow chart into a preset harmless attack engine, and automatically generating the harmless attack task by the preset harmless attack engine.

Specifically, through the information in the attack knowledge graph, the specific attack scenarios corresponding to the different attack cases are determined, including the identities of the attackers, the attack targets, the attack methods used, and the attack paths, by determining the attack scenarios and case details, different types of security threats can be deeply understood, thereby helping the security teams prepare corresponding coping strategies and protection measures; the attackers, the attack targets, the attack methods, and the attack paths are drawn into the attack flow chart in a graphical manner to present the overall processes and correlations of the attack events, and through the graphical attack flow chart, the key elements and processes of the attack events can be intuitively presented, which is helpful for team members to understand the complexities and correlations of the attack events; and the drawn attack flow chart is imported into the preset harmless attack engine, and the preset harmless attack engine can automatically generate the harmless attack task according to the information in the chart, thereby simulating the attack events without causing actual harm to the system, and through the task generated by the preset harmless attack engine, real attack behaviors can be simulated in a controlled environment to evaluate the security and weaknesses of the system and help the organizations formulate effective security protection strategies. In conclusion, this step can help the organizations understand the details of the attack cases in different attack scenarios in detail, and present the attack processes in a graphical manner, thereby better understanding the essence and processes of the attack events, by importing into the preset harmless attack engine to generate the harmless attack task, real attack behaviors can be safely simulated to evaluate the defense capability of the system and help the organizations timely discover and solve potential security vulnerabilities. This step combines the technical means of the attack knowledge graph, the attack flow chart, and the harmless attack engine, thereby providing the organizations with comprehensive security assessment and protection capabilities, which is helpful to improving the overall security of the system.

In an embodiment of the present application, there is provided a harmless attack verification and analysis method, and said “determining a number of paths and a number of nodes of attack paths in the harmless attack task, and decomposing the harmless attack task into a plurality of sub-tasks based on the number of paths and the number of nodes of the attack paths” includes: determining the number of paths and the number of nodes in the attack paths in the harmless attack task, calculating a product of the number of paths and the number of nodes, and decomposing the harmless attack task into the plurality of sub-tasks according to a result of the product.

Specifically, the number of paths of the attack paths refers to the number of all possible paths from the attackers to a target system, the number of nodes refers to the total number of nodes (such as the attackers, intermediate nodes, target system, etc.) involved in the attack paths, and by calculating the product of the number of paths and the number of nodes, an indicator representing the complexity of the attack task can be obtained; and according to the result of the product of the number of paths and the number of nodes, the original harmless attack task is decomposed into the plurality of sub-tasks, each of which covers a part of the attack paths or specific nodes, decomposing the task can help to reduce the complexity of the task, improve execution efficiency, and better manage the task execution process. This step can be executed in parallel or in stages by decomposing the complex attack task into the plurality of sub-tasks, thereby improving task execution efficiency; decomposing the task enables the entire attack process to be managed and monitored more easily, and allows for clearer tracking of task execution progress and results; decomposing the task into the sub-tasks can make the attack process more controllable, which is helpful to avoiding the occurrence of unexpected situations and better mastering the direction and target of the attack; and through reasonable allocation and execution of the sub-tasks, computing resources and time can be more effectively utilized, thereby improving the efficiency and success rate of the attack task. In conclusion, this step of decomposing the harmless attack task into the plurality of sub-tasks is an effective task management and execution strategy, which can improve task execution efficiency, reduce management complexity, and optimize resource utilization, and this decomposition method is helpful to better understanding and controlling the complexity of the attack task, improving the accuracy and comprehensiveness of attack evaluation, and at the same time is helpful the organization to more effectively plan and implement security protection measures.

In an embodiment of the present application, there is provided a harmless attack verification and analysis method, and said “acquiring path information of each attack path, determining a complexity of the each attack path based on the path information” includes: acquiring the path information of the each attack path, where the path information includes static indicators and dynamic indicators, and analyzing the static indicators and the dynamic indicators to determine indicator values corresponding to the static indicators and the dynamic indicators; converting the static indicators and the dynamic indicators into vectors respectively, and normalizing vectorized static indicators and vectorized dynamic indicators to obtain weights corresponding to the static indicators and the dynamic indicators respectively; determining a static complexity of the each attack path according to the indicator values and weights of the static indicators, and determining a dynamic complexity of the each attack path according to the indicator values and weights of the dynamic indicators; and adding the static complexity of the each attack path and the dynamic complexity of the each attack path to obtain the complexity of the each attack path.

Specifically, the path information of the each attack path is acquired, where the path information includes the static indicators and the dynamic indicators, and the static indicators and the dynamic indicators are analyzed to determine indicator values corresponding to the static indicators and the dynamic indicators; for each static indicator and each dynamic indicator, they are converted into vector forms, and each vector is normalized to map its value to a standard range to ensure that the weights of different indicators can be compared and combined; the static complexity of the each attack path is calculated according to the indicator values and weights of the static indicators, and the dynamic complexity of the each attack path is calculated according to the indicator values and weights of the dynamic indicators; and the static complexity and the dynamic complexity are added to obtain the overall complexity of the each attack path. In this step, the complexities of the attack paths can be more comprehensively evaluated by considering the static indicators and the dynamic indicators, which is helpful to determining the difficulty and risk of the attack; the weights are converted into vectors and normalized to provide quantified weights, so that weighting can be made between different indicators; by analyzing the indicator values and weights of different indicators, it is possible to help to optimize the planning of the attack paths and improving the efficiency and success rate of the attack; accurately calculating the complexities of the attack paths is helpful for the security teams to formulate more effective coping strategies, thereby strengthening the security protection and emergency coping capabilities of the system. In conclusion, by analyzing, converting, and normalizing the static indicators and the dynamic indicators of the attack paths, the complexities of the attack paths can be more comprehensively evaluated, thereby providing quantified indicators for the security teams to guide security decision-making and the formulation of coping measures, and this method is helpful to improving the efficiency and accuracy of planning the attack paths and optimizing the formulation of security protection strategies, thereby enhancing the overall security of the system.

In an embodiment of the present application, there is provided a harmless attack verification and analysis method, and said “analyzing the static indicators and the dynamic indicators to determine indicator values corresponding to the static indicators and the dynamic indicators” includes: determining the static indicators and the dynamic indicators, where the static indicators include path length, vulnerability exploitation difficulty, and tool maturity, and the dynamic indicators include protection device coverage, environment context matching degree, and attacker resource requirements, and respectively evaluating and assigning values to the indicators in the static indicators and the dynamic indicators to obtain the indicator values corresponding to the static indicators and the dynamic indicators.

Specifically, in terms of determining the static indicators and the dynamic indicators, the static indicators include path length, vulnerability exploitation difficulty, and tool maturity, and the dynamic indicators include protection device coverage, environment context matching degree, and attacker resource requirements; where the path length is the number of steps involved in the attack path, and a longer path means a more complex attack process; the vulnerability exploitation difficulty is the difficulty for an attacker to exploit a vulnerability for an attack, such as the public degree of the vulnerability, whether professional knowledge is required, etc.; the tool maturity is the maturity of a tool or technology used in an attack, including the function, stability, and ease of use of the tool; the protection device coverage is the detection and blocking capability of a protection device for the nodes or traffic in the attack path; the environment context matching degree is whether an attacker's behavior matches the environment context of a target system, such as the attacker's location, the device used, etc.; the attacker resource requirements are the resources, skills, and time costs required for an attack, including an attacker's computing resources, network bandwidth, etc.; and for each static indicator and each dynamic indicator, professional knowledge, security tools, and intelligence data can be used for evaluation to determine their value ranges. In this step, the complexities, risks, and implementation difficulty of the attack paths can be comprehensively evaluated by considering the static indicators and the dynamic indicators, which is helpful to formulating corresponding security strategies; accurately evaluating the values of the indicators can provide decision-making support for the security teams to help them prioritize the processing of high-risk attack paths; understanding the dynamic indicators such as protection device coverage and environment context matching degree can help to optimize security protection measures and improve system security; the evaluation of the dynamic indicators can help the security teams detect and respond to the attack more quickly, thereby reducing losses. In conclusion, determining the static indicators and the dynamic indicators and evaluating and assigning values to them are helpful to comprehensively evaluating the complexities and risks of the attack paths, guiding security decision-making, and optimizing security protection measures, and this method can improve the security teams' awareness and coping capabilities regarding the attack paths, thereby enhancing the overall security of the system.

In an embodiment of the present application, there is provided a harmless attack verification and analysis method, said “determining a static complexity of the each attack path according to the indicator values and weights of the static indicators, and determining a dynamic complexity of the each attack path according to the indicator values and weights of the dynamic indicators” includes: calculating the static complexity of the each attack path according to the indicator values and weights of the static indicators, where a calculation formula for the static complexity of the each attack path is:

$$A = {\sum }_{i = 1}^{n} qi * li ,$$

where A is the static complexity of the each attack path, qi is the weight of an i-th indicator in the static indicators, li is the indicator value of the i-th indicator in the static indicators, and n is a number of indicators in the static indicators; and
calculating the dynamic complexity of the each attack path according to the indicator values and weights of the dynamic indicators, where a calculation formula for the dynamic complexity of the each attack path is:

$$B = {\sum }_{i = 1}^{m} pi * ji ,$$

where B is the dynamic complexity of the each attack path, pi is the weight of an i-th indicator in the dynamic indicators, Ji is the indicator value of the i-th indicator in the dynamic indicators, and m is a number of indicators in the dynamic indicators.

In an embodiment of the present application, there is provided a harmless attack verification and analysis method, and said “determining attack priorities of the sub-tasks based on the complexities of the attack paths” includes: presetting an attack priority-complexity interval correspondence, where in the attack priority-complexity interval correspondence, each complexity interval is associated with a corresponding attack priority; and acquiring a complexity of each sub-task, and based on a mapping relationship of a complexity interval to which the complexity belongs in the attack priority-complexity interval correspondence, selecting an attack priority corresponding to the complexity interval as the attack priority of the each sub-task.

Specifically, the attack priority-complexity interval correspondence is preset, different complexity levels are divided into different intervals, and one corresponding attack priority is designated for each interval; for each sub-task or attack path, its complexity value can be obtained through the previous complexity evaluation method, and the complexity value of the sub-task is matched with the preset complexity intervals to determine the complexity interval to which it belongs; and according to the complexity interval to which the complexity of the sub-task belongs, a corresponding attack priority is found in the attack priority-complexity interval correspondence. The attack priority is selected as the attack priority of the sub-task so as to determine its processing priority in security emergency response or security planning. This step can ensure that attack tasks with different complexities are assigned appropriate priorities by mapping the complexity to the preset attack priority-complexity interval correspondence, which is helpful to reasonably allocating security resources; determining the attack priorities of the sub-tasks can help the security teams respond more quickly to high-priority attacks, thereby reducing security risks; determining the priorities of the attack tasks according to their different complexities is helpful to the security teams to formulate more effective security planning and resource allocation strategies, thereby improving the overall security. In conclusion, by mapping the complexities of the sub-tasks to the attack priority-complexity interval correspondence, the attack priorities of the sub-tasks can be effectively determined, thereby improving the emergency response efficiency of the security teams, optimizing security planning and resource allocation, and thus enhancing the overall security of the system. This method is helpful to processing and coping with attacks with different complexities in a more organized manner.

In an embodiment of the present application, there is provided a harmless attack verification and analysis method, and said “determining an attack sequence of the sub-tasks based on the attack priorities, and performing simulated attack verification on a protection boundary by the sub-tasks in the attack sequence” includes: determining dependency relationships among the sub-tasks, constructing a directed acyclic graph of the sub-tasks according to the dependency relationships, and generating a topological sequence of the sub-tasks according to the directed acyclic graph; determining the attack priorities of the sub-tasks, and adjusting the topological sequence according to the attack priorities of the sub-tasks to obtain the attack sequence of the sub-tasks; and allocating the sub-tasks to different simulation nodes, and executing a corresponding sub-task of each simulation node in the attack sequence to perform the simulated attack verification on the protection boundary.

Specifically, the dependency relationships among the sub-tasks are determined, that is, which sub-tasks need to be executed before other sub-tasks. According to these dependency relationships, the directed acyclic graph of the sub-tasks is constructed, where nodes represent the sub-tasks, and edges represent the dependency relationships among the sub-tasks. The topological sequence is generated in the directed acyclic graph to ensure that the sub-tasks are executed in an order constrained by the dependency relationships, thereby avoiding circular dependencies; the topological sequence is adjusted according to the attack priorities to ensure that high-priority sub-tasks are executed first, and each sub-task is allocated to a different simulation node to ensure parallel execution of different sub-tasks; and the corresponding sub-task of each simulation node is executed in the attack sequence, simulating an actual attack scenario to verify the protection boundary. This step can optimize the execution sequence of the attack tasks by constructing the directed acyclic graph and determining the attack priorities, thereby ensuring that high-priority tasks are executed first, and improving security response efficiency; by executing the attack tasks according to the topological sequence and the attack priorities, errors and confusion in the attack processes can be reduced, improving the accuracy of the attack; allocating the sub-tasks to different simulation nodes and executing them in the attack sequence can improve simulation efficiency, accelerate the verification process, and reduce attack detection and response time; through the simulated attack verification, the security and effectiveness of the protection boundary can be comprehensively tested, potential vulnerabilities can be discovered and repaired in a timely manner, and the overall security of the system can be improved. In conclusion, by constructing the directed acyclic graph, generating the topological sequence, determining the attack priorities and adjusting the attack sequence, and allocating the sub-tasks to the different simulation nodes and executing the simulated attack verification, the attack execution sequence can be optimized, errors can be reduced, simulation efficiency can be improved, and the protection boundary can be comprehensively verified, thereby effectively improving the security and coping capabilities of the system.

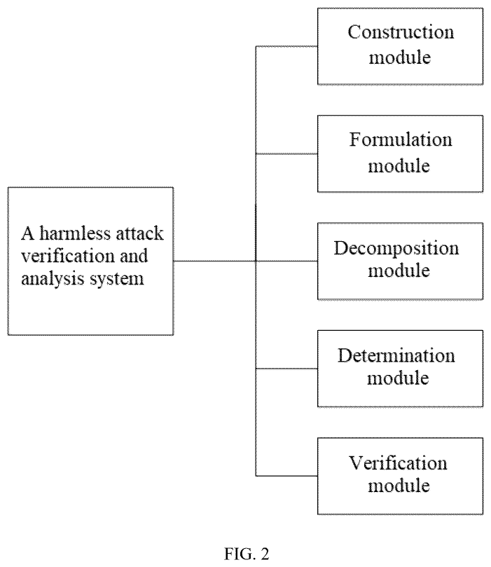

As shown in FIG. 2, in an embodiment of the present application, there is provided a harmless attack verification and analysis system, including: a construction module configured to acquire multi-source security data, determine attack cases in the multi-source security data, and construct an attack knowledge graph based on the attack cases in the multi-source security data; a formulation module configured to construct a scenario-based attack flow chart based on the attack knowledge graph, and formulate a harmless attack task based on the attack flow chart; a decomposition module configured to determine a number of paths and a number of nodes of attack paths in the harmless attack task, and decompose the harmless attack task into a plurality of sub-tasks based on the number of paths and the number of nodes of the attack paths; a determination module configured to acquire path information of the each attack path, determine a complexity of the each attack path based on the path information, and determine attack priorities of the sub-tasks based on the complexities of the attack paths; and a verification module configured to determine an attack sequence of the sub-tasks based on the attack priorities, and perform simulated attack verification on a protection boundary by the sub-tasks in the attack sequence.

In conclusion, the embodiments of the present disclosure provide a harmless attack verification and analysis method and system, which includes: acquiring multi-source security data, determining attack cases in the multi-source security data to construct an attack knowledge graph; constructing a scenario-based attack flow chart based on the attack knowledge graph, and formulating a harmless attack task based on the attack flow chart; determining a number of paths and a number of nodes of attack paths in the harmless attack task, and decomposing the harmless attack task into a plurality of sub-tasks based on the number of paths and the number of nodes of the attack paths; acquiring path information of each attack path, determining a complexity of the each attack path based on the path information, and determining attack priorities of the sub-tasks based on the complexities of the attack paths; and determining an attack sequence of the sub-tasks based on the attack priorities, and performing simulated attack verification on a protection boundary by the sub-tasks in the attack sequence. In the present disclosure, the security and weaknesses of the protection boundary are determined by simulating real attack behaviors, to help to discover and solve potential security vulnerabilities, thereby improving the overall security of an information system and guaranteeing the security of the information system and data.

Finally, it should be noted that apparently, those of skill in the art can make various modifications and variations to the present disclosure without departing from the spirit and scope of the present disclosure. As such, if these modifications and variations of the present disclosure fall within the scope of the claims of the present disclosure and their equivalent technologies, the present disclosure is also intended to include these modifications and variations.

The above description is only an embodiment of the present disclosure, but it should not be construed as limiting the scope of the present disclosure. Any structural changes made based on the present disclosure, as long as they do not lose the essence of the present disclosure, should be regarded as falling within the protection scope of the present disclosure. Those of skill in the art can clearly understand that, for the convenience and brevity of description, the specific operating process and related explanations of the above-described platform can refer to the corresponding process in the aforementioned platform embodiments, which will not be repeated here.

The term “include” or any other similar wording is intended to cover a non-exclusive inclusion, such that a process, platform, article, or device/platform including a series of elements not only includes those elements but also includes other elements not explicitly listed, or also includes elements inherent to the process, platform, article, or device/platform.

So far, the technical solutions of the present disclosure have been described in conjunction with the further implementations shown in the drawings. However, it is easy for those of skill in the art to understand that the protection scope of the present disclosure is apparently not limited to these specific implementations. Without departing from the principle of the present disclosure, those of skill in the art can make equivalent changes or substitutions to the closely related technical features, and these changed or substituted technical solutions will all fall within the protection scope of the present disclosure.

The above are only the preferred embodiments of the present disclosure and are not intended to limit the protection scope of the present disclosure.

What is claimed is:

1. A harmless attack verification and analysis method, comprising:
acquiring multi-source security data, determining attack cases in the multi-source security data, and constructing an attack knowledge graph based on the attack cases in the multi-source security data;
constructing a scenario-based attack flow chart based on the attack knowledge graph, and formulating a harmless attack task based on the attack flow chart;
determining a number of paths and a number of nodes of attack paths in the harmless attack task, and decomposing the harmless attack task into a plurality of sub-tasks based on the number of paths and the number of nodes of the attack paths;
acquiring path information of each attack path, determining a complexity of the each attack path based on the path information, and determining attack priorities of the sub-tasks based on the complexities of the attack paths; and
determining an attack sequence of the sub-tasks based on the attack priorities, and performing simulated attack verification on a protection boundary by the sub-tasks in the attack sequence.

2. The harmless attack verification and analysis method according to claim 1, wherein said “acquiring multi-source security data, determining attack cases in the multi-source security data, and constructing an attack knowledge graph based on the attack cases in the multi-source security data” comprises:
acquiring the multi-source security data on a network through a web crawler, and performing preprocessing on the multi-source security data, wherein the preprocessing comprises data cleaning and data standardization processing;
identifying attack events from the preprocessed multi-source security data, and determining the attack cases in the multi-source security data based on the attack events;
using a preset extraction model to extract entities involved in the attack cases, and analyzing relationships among different entities in the attack cases based on dependency syntax; and
constructing the attack knowledge graph based on the entities and the relationships among the entities, and periodically updating the attack knowledge graph.

3. The harmless attack verification and analysis method according to claim 2, wherein said “constructing a scenario-based attack flow chart based on the attack knowledge graph, and formulating a harmless attack task based on the attack flow chart” comprises:
determining attack scenarios corresponding to different attack cases in the attack knowledge graph, and determining attackers, attack targets, attack methods, and attack paths in the attack cases in different attack scenarios; and
drawing the attackers, the attack targets, the attack methods, and the attack paths into an attack flow chart in a graphical manner, importing the attack flow chart into a preset harmless attack engine, and automatically generating the harmless attack task by the preset harmless attack engine.

4. The harmless attack verification and analysis method according to claim 3, wherein said “determining a number of paths and a number of nodes of attack paths in the harmless attack task, and decomposing the harmless attack task into a plurality of sub-tasks based on the number of paths and the number of nodes of the attack paths” comprises:
determining the number of paths and the number of nodes in the attack paths in the harmless attack task, calculating a product of the number of paths and the number of nodes, and decomposing the harmless attack task into the plurality of sub-tasks according to a result of the product.

5. The harmless attack verification and analysis method according to claim 4, wherein said “acquiring path information of each attack path, determining a complexity of the each attack path based on the path information” comprises:
acquiring the path information of the each attack path, wherein the path information comprises static indicators and dynamic indicators, and analyzing the static indicators and the dynamic indicators to determine indicator values corresponding to the static indicators and the dynamic indicators;
converting the static indicators and the dynamic indicators into vectors respectively, and normalizing vectorized static indicators and vectorized dynamic indicators to obtain weights corresponding to the static indicators and the dynamic indicators respectively;
determining a static complexity of the each attack path according to the indicator values and weights of the static indicators, and determining a dynamic complexity of the each attack path according to the indicator values and weights of the dynamic indicators; and
adding the static complexity of the each attack path and the dynamic complexity of the each attack path to obtain the complexity of the each attack path.

6. The harmless attack verification and analysis method according to claim 5, wherein said “analyzing the static indicators and the dynamic indicators to determine indicator values corresponding to the static indicators and the dynamic indicators” comprises:
determining the static indicators and the dynamic indicators, wherein the static indicators comprise path length, vulnerability exploitation difficulty, and tool maturity, and the dynamic indicators comprise protection device coverage, environment context matching degree, and attacker resource requirements, and respectively evaluating and assigning values to the indicators in the static indicators and the dynamic indicators to obtain the indicator values corresponding to the static indicators and the dynamic indicators.

7. The harmless attack verification and analysis method according to claim 5, wherein said “determining a static complexity of the each attack path according to the indicator values and weights of the static indicators, and determining a dynamic complexity of the each attack path according to the indicator values and weights of the dynamic indicators” comprises:
calculating the static complexity of the each attack path according to the indicator values and weights of the static indicators, wherein a calculation formula for the static complexity of the each attack path is:
$$A = {\sum }_{i = 1}^{n} qi * li ,$$
where A is the static complexity of the each attack path, qi is the weight of an i-th indicator in the static indicators, li is the indicator value of the i-th indicator in the static indicators, and n is a number of indicators in the static indicators; and
calculating the dynamic complexity of the each attack path according to the indicator values and weights of the dynamic indicators, wherein a calculation formula for the dynamic complexity of the each attack path is:
$$B = {\sum }_{i = 1}^{m} pi * ji ,$$
where B is the dynamic complexity of the each attack path, pi is the weight of an i-th indicator in the dynamic indicators, Ji is the indicator value of the i-th indicator in the dynamic indicators, and m is a number of indicators in the dynamic indicators.

8. The harmless attack verification and analysis method according to claim 5, wherein said “determining attack priorities of the sub-tasks based on the complexities of the attack paths” comprises:
presetting an attack priority-complexity interval correspondence, wherein in the attack priority-complexity interval correspondence, each complexity interval is associated with a corresponding attack priority; and
acquiring a complexity of each sub-task, and based on a mapping relationship of a complexity interval to which the complexity belongs in the attack priority-complexity interval correspondence, selecting an attack priority corresponding to the complexity interval as the attack priority of the each sub-task.

9. The harmless attack verification and analysis method according to claim 8, wherein said “determining an attack sequence of the sub-tasks based on the attack priorities, and performing simulated attack verification on a protection boundary by the sub-tasks in the attack sequence” comprises:
determining dependency relationships among the sub-tasks, constructing a directed acyclic graph of the sub-tasks according to the dependency relationships, and generating a topological sequence of the sub-tasks according to the directed acyclic graph;
determining the attack priorities of the sub-tasks, and adjusting the topological sequence according to the attack priorities of the sub-tasks to obtain the attack sequence of the sub-tasks; and
allocating the sub-tasks to different simulation nodes, and executing a corresponding sub-task of each simulation node in the attack sequence to perform the simulated attack verification on the protection boundary.

10. A harmless attack verification and analysis system, comprising:
a construction module configured to acquire multi-source security data, determine attack cases in the multi-source security data, and construct an attack knowledge graph based on the attack cases in the multi-source security data;
a formulation module configured to construct a scenario-based attack flow chart based on the attack knowledge graph, and formulate a harmless attack task based on the attack flow chart;
a decomposition module configured to determine a number of paths and a number of nodes of attack paths in the harmless attack task, and decompose the harmless attack task into a plurality of sub-tasks based on the number of paths and the number of nodes of the attack paths;
a determination module configured to acquire path information of the each attack path, determine a complexity of the each attack path based on the path information, and determine attack priorities of the sub-tasks based on the complexities of the attack paths; and
a verification module configured to determine an attack sequence of the sub-tasks based on the attack priorities, and perform simulated attack verification on a protection boundary by the sub-tasks in the attack sequence.
